(19) United States
(12) Patent Application Publication
(10) Pub. No.: US 2005/0029397 A1
(43) Pub. Date: Feb. 10, 2005

(54) Flying saucer

(76) Inventor: Charles Christopher Yearwood, New Castle (KN)

Correspondence Address: CHARLES CHRISTOPHER YEARWOOD, SEA HAVEN, NEW CASTLE, WEST INDIES, KN

(21) Appl. No.: 10/622,792

(22) Filed: Jul. 21, 2003

(51) Int. Cl. B64D 35/00

(52) U.S. Cl. 244/60

(57) ABSTRACT

The Flying Saucer is a vertical take off and landing vehicle for space flight. The vehicle comprises a metal sphere rotating around a hub to which are affixed four magnetic coils in a circle equidistantly with a fifth coil at the center which is surrounde by a hoolow circular glass tube filled with rubidium gas, tube and magnets with axes vertical The inner wall of the tube is made of more dense glass with a phosphor coating, and the top of the tube has a less dense glass outer coating on top of the more dense glass. When an electric motor rotates a vertical column, supported by a bearing at the center of the hub which is attached to the top and bottom of the sphere, the metal sphere rotating around the magnetic coils causes a continuous buildup of electric charge on the sphere and magnetic field, which heats and excites the rubidium gas in the tube so it interacts with the phosphor layer to produce light which is slowed down by the hot rubidium gas; causing a radial Einstein time change over distance, causing increased centrifugal force radially, causing acceleration of sphere rotation, resulting in more mechanical energy than needed to produce the slowed light by the previously mentioned process, with excess energy turning the electric motor as a generator to charge the battery. The slowed light reflected down vertically produces vertical thrust from the light (force of light equals wattage divided by velocity), and vertical thrust from Einstein time change over distance. Hinged mirrors at exhaust at bottom of sphere deflect the vertical light at an angle for horizontal thrust. The part of the hub which the tube rests on, and the exhaust at the bottom of the sphere, are transparent.

### BACKGROUND OF THE INVENTION

My invention has vertical take off and landing capability using slowed down light as propulsion. The force of light is equal to the wattage of light divided by the velocity of light; so light which has been slowed down has a greater force than normal light. Also, the Einstein time effect caused by the slowed down light, causes a time change over distance; which converts the velocity of the flying saucer into acceleration.

My invention also makes use of slowed light reflecting around in a circle to cause a radial time change over distance due to an Einstein effect; in order to increase mechanical rotation of a metal sphere around it caused by an increase in centrifugal force.

An electric charge builds up on the conducting sphere rotating in the magnetic field, and the rotating charge buildup in turn increases the magnetic field.

The changing magnetic field and rotating electric charge excites and heats rubidium gas in a circular hollow tube;creating light due to the excited gas interacting with the phosphor layer coating on the inside wall of thehollow tube.

The light created slows down to a velocity of 90 meters per second while Passing through the hot rubidium gas.

For every ninety watts of slowed light reflected out of the exhaust below the flying saucer, one Newton of force is produced. Also, the time change over distance due to the slowed light, converts the flying saucer velocity into acceleration.

After an electric motor with a gear system starts the sphere rotating, it continues to rotate with its own energy and the motor becomes a generator (connected to a battery).

The flying saucer invention indeavors to fly into space from Earth, accelerate to faster than the speed of light, slow down, then orbit the nearest solar system in space called the Southern Cross five light years away.

The machine's journey would take two weeks to bring photographs back to Earth.

Slowing light with hot rubidium gas is described in
Physical Review Focus
Slow light for the rest of us.
29 Jun. 1999
COPYRIGHT 1999, The American Physical Society.

### BRIEF SUMMARY OF THE INVENTION

There are five magnets arranged in a horizontal plane with axes vertical; one coil in the center, and four coils surrounding the central coil equidistantly.

Between the central coil and outer coils is a circular hollow tube filled with hot rubidium gas which slows light down.

As a metal sphere rotates around the above assembly, electric charge builds up on the sphere, and this rotating charge increases the magnetic field, which increases the rotating charge; a steady buildup of charge and magnetic field resulting.

The increasing charge and field excites and heats rubidium gas in the circular Hollow tube, which interacts with a phosphor layer on the inner wall of the tube to make light which is slowed down by hot rubidium gas to less than motion velocity while bouncing around in a circle inside the tube.

The Einstein effect of the slowed light causes a time change over distance, radially, increasing centrifugal force radially; which accelerates the rotation of the sphere which provides the energy for the previously mentioned processes.

The force of the slowed light reflected out of the exhaust below the flying Saucer is equal to the wattage divided by the velocity of light. The Einstein time change over distance also accelerates the flying saucer to faster than the speed of light.

A small quantity of battery power is needed so the electric motor and gears start the sphere rotating; then it continues to rotate with energy of the entire system, and the motor becomes a generator to charge the battery.

No extra energy needed to fly five light years in two weeks.

The nearest Southern Cross Constellation can be examined, then the flying saucer return to Earth.

### BRIEF DESCRIPTION OF SEVERAL VIEWS OF THE DRAWINGS

FIG. 1 is a three dimensional view of the flying saucer.

FIG. 1A is a horizontal cross section of the landing gear.

FIG. 1B is a vertical cross section of the landing gear.

FIG. 2 is a horizontal cross section of the flying saucer showing the arrangement of the magnetic coils, circular hollow tube, electric motor with gears to turn sphere, structure of bearings and supports to rotate sphere relative to stationary parts.

FIG. 3 is a vertical cross section of sphere rotating around stationary magnetic coils and circular hollow tube.

FIG. 4 is a vertical cross section of magnetic coils and circular hollow tube, showing layers of different density glass and phosphor layer making up the wall of the circular hollow tube.

FIG. 5 is a vertical view of the circular hollow tube filled with slowed light, showing Radial direction of Einstein time change with distance and resulting radial force.

FIG. 6 is a horizontal view of rotating sphere and stationary circular hollow tube showing direction of force; caused by Einstein time change of slowed light in the tube; and increasing centrifugal force and rotational speed of the sphere.

FIG. 7 is a vertical view of tube and rotating sphere showing direction of force due to Einstein time change over distance which increases centrifugal force and rotational speed of the sphere.

FIG. 8 is a horizontal cross section of stationary hub with light from tube reflected through transparent part of hub to transparent exhaust at the bottom of the sphere with hinged mirrors which can change their angle for horizontal thrust. Sphere rotates around hub.

FIG. 9 is a vertical cross section of flying saucer showing metal sphere and its supports Surrounding hub with bearing to fascillitate sphere rotating around hub, sphere exhaust and mirrors. Electric motor attached to hub, which uses gears to start sphere rotating around hub.

### DETAILED DESCRIPTION OF THE INVENTION

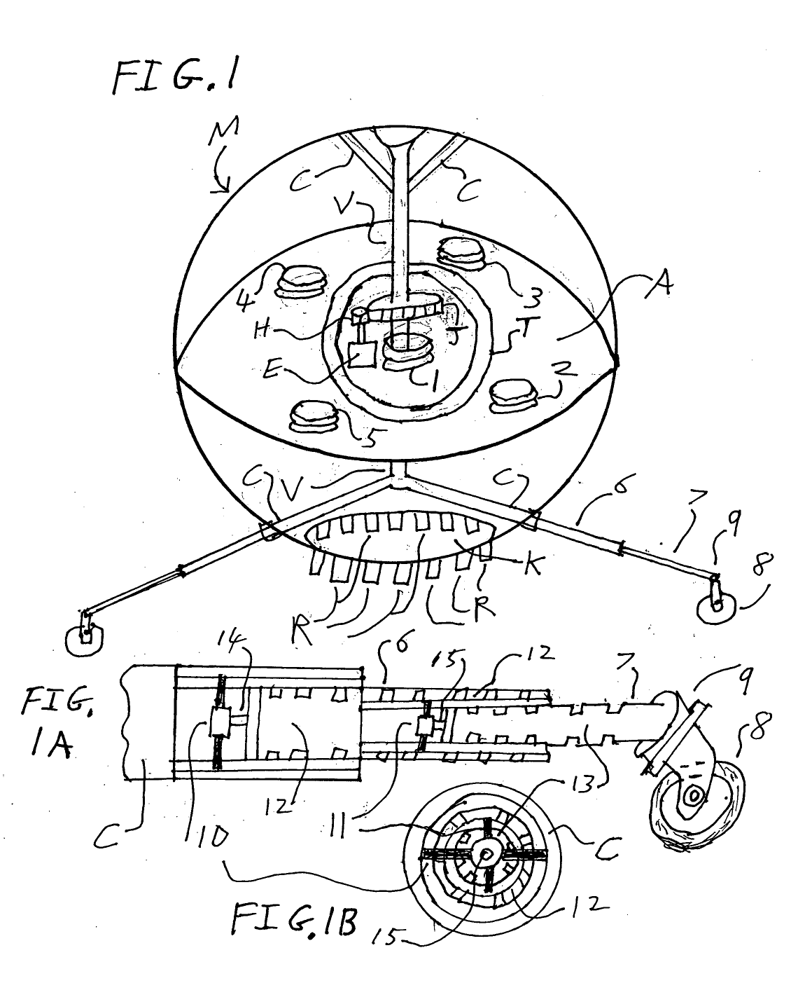

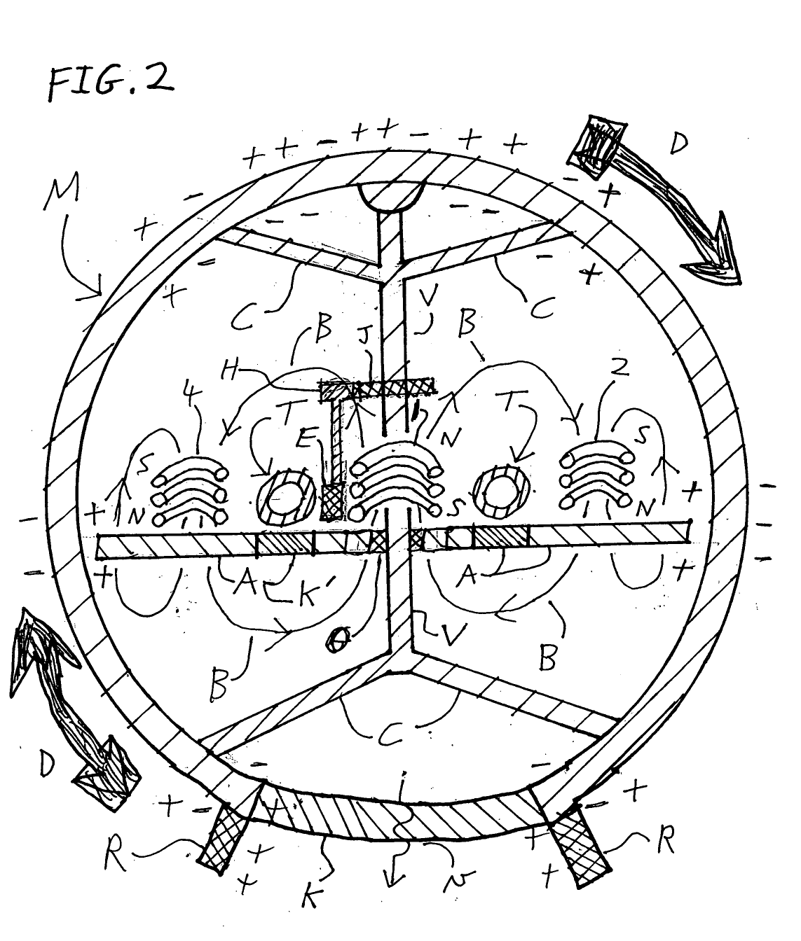

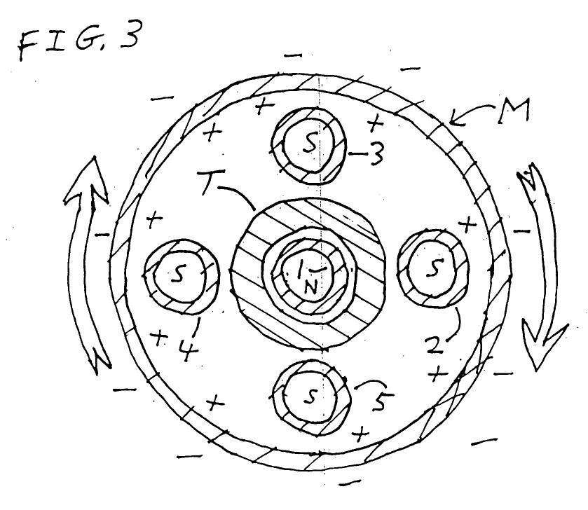

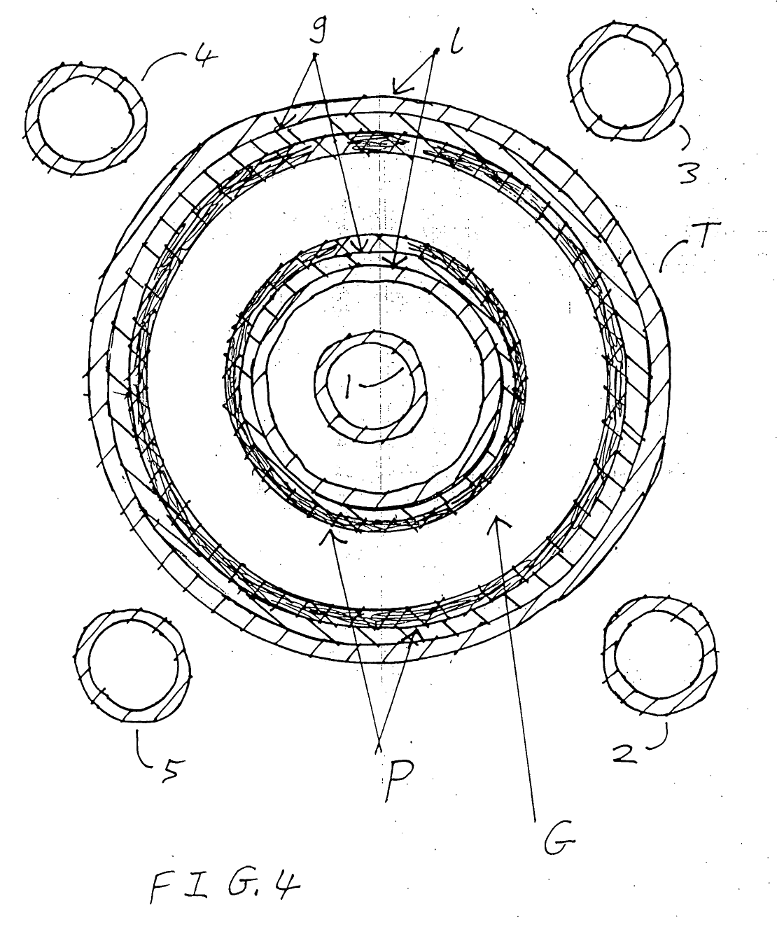

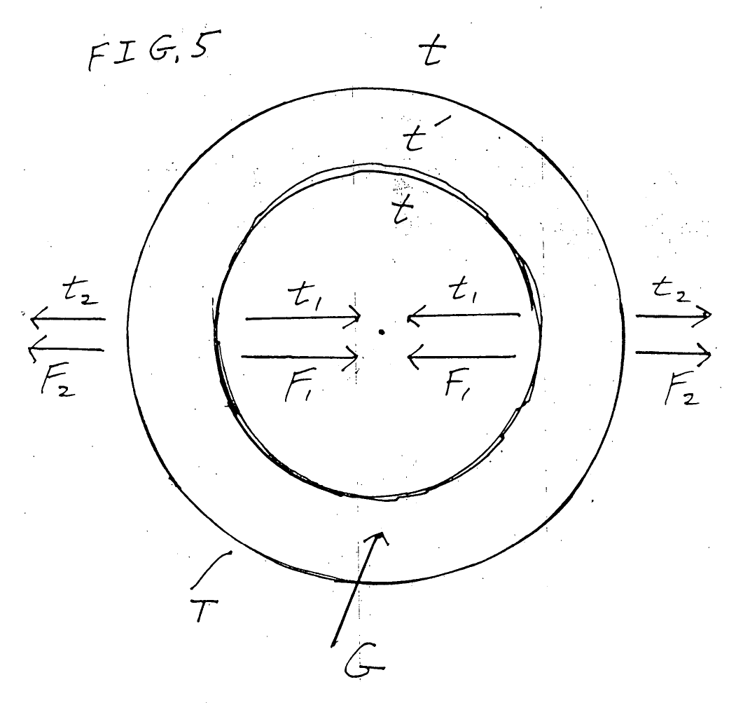

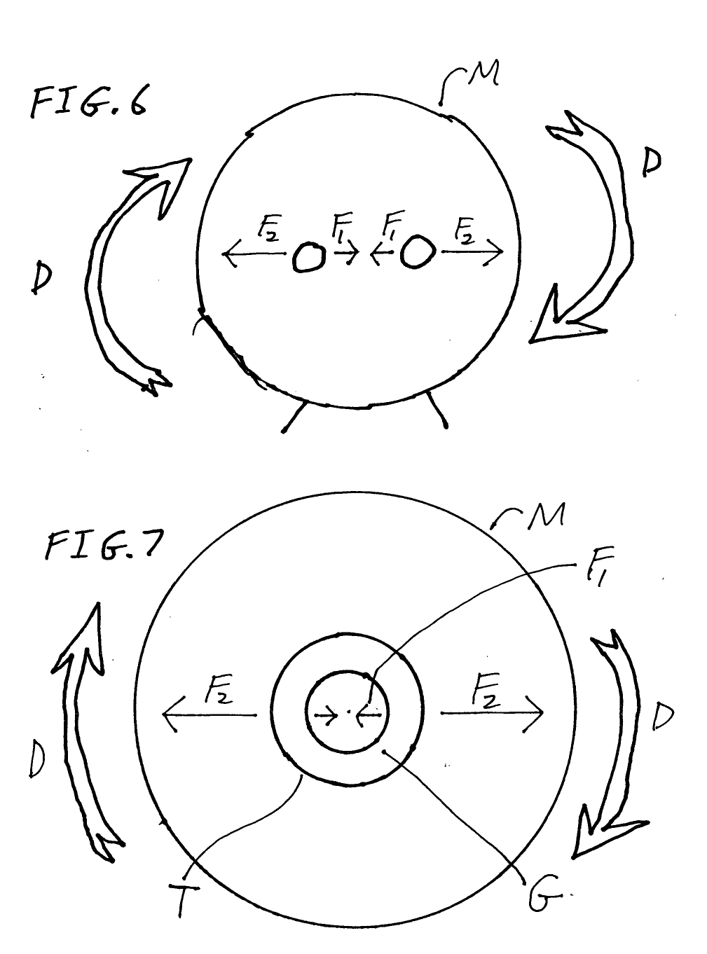

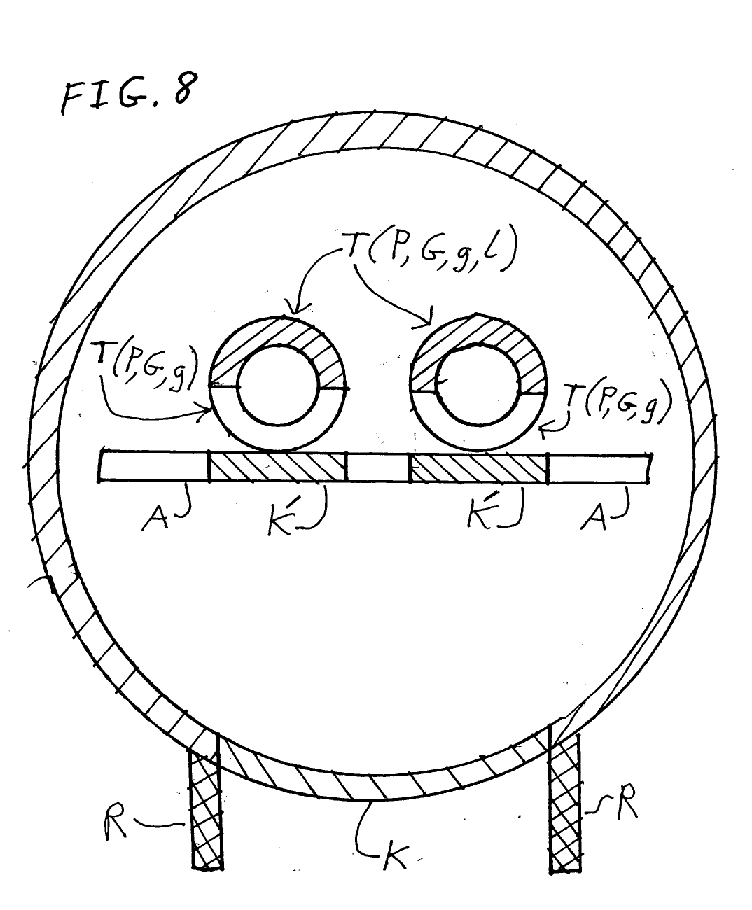

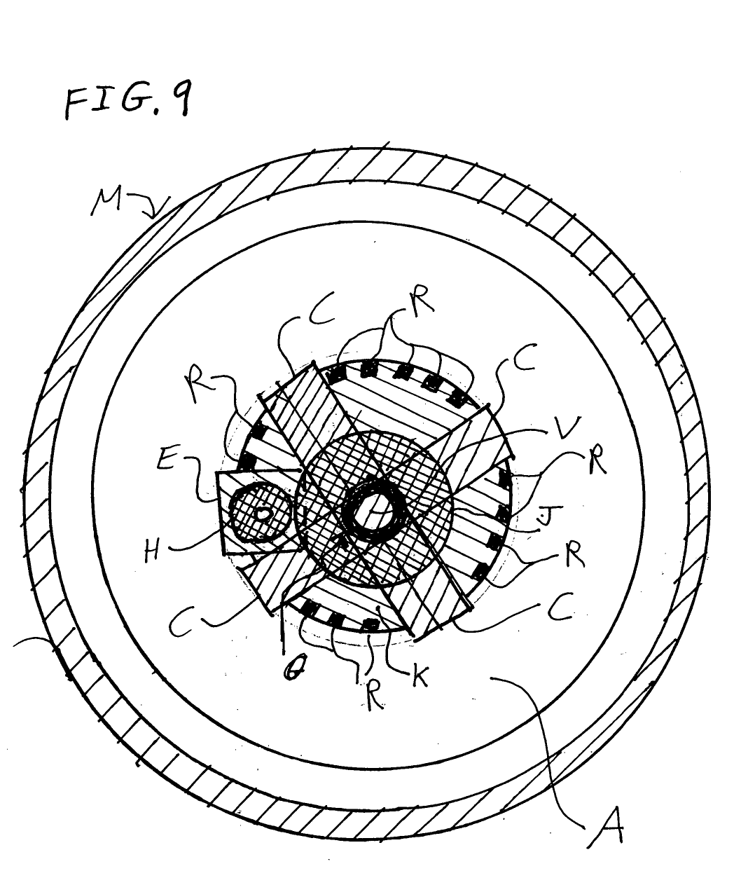

There are five magnetic coils 1,2,3,4,5, in a horizontal plane with axes vertical arranged with coil 1 in the center; and surrounded equidistantly by coils 2,3,4,5, see FIG. 1, FIG. 3, FIG. 4 Coils 1,2,4, only shown in FIG. 2

A circular hollow tube T has an outer wall of less dense glass, 1, and an inner wall made of more dense glass, g, with a phosphor coating, P, on the inner wall. The tube is filled with hot rubidium gas, G, see FIG. 4

The hollow tube T surrounds the magnetic coil, 1, with coils 2,3,4,5, outside of it; the hollow circular tube in the same horizontal plane as the magnetic coils. See FIG. 1, FIG. 3, FIG. 4, FIG. 2 only shows coils 1,2,4, and tube T.

Only the top half of the circular hollow tube wall has the low density glass, 1,; so the light is reflected downwards through the transparent part of the hub, K′, and through the transparent exhaust, K, at the bottom of the sphere; where hinged mirrors R can add horizontal thrust to the normal vertical thrust by deflecting the vertically shining light exiting the exaust. See FIG. 8, FIG. 9

The assembly of circular hollow tube T and magnetic coils 1,2,3,4,5, is attached to a circular, horizontal, flat hub A with a bearing O at its center to fascillitate the rotation of a vertical support V at its center which is attached to a metal sphere M which surrounds the hub A and rotates around it. Additional supports, C, attache the sphere M to vertical support V. See FIG. 1, FIG. 2, FIG. 9,

Sphere M rotates in directin, D, See FIG. 2, FIG. 3, FIG. 6, FIG. 7, A battery powered motor, E, with a vertical axis rotating shaft which has a cog wheel, H, on the end, drives a larger cog wheel, J, which surrounds the vertical support V. The motor E can thus be used to rotate the metal sphere M with the vertical support V passing through bearing O at the center of hub A which fascillitates the rotation of sphere M around the hub A. See FIG. 1, FIG. 2, FIG. 9

The metal sphere M rotating through the magnetic field B caused by magnets 1,2,3,4,5, causes a buildup of positive charge +, and negative charge −, on the metal sphere M. See FIG. 2, FIG. 3,

The magnetic field B is produced by the north magnetic pole N of the central coil, and south magnetic pole S of outer coils 2,3,4,5, See FIG. 2, FIG. 3,

The rotating electric charges − and + on the rotating metal sphere M increases the magnetic field in magnetic coils 1,2,3,4,5, which in turn increases the electric charges on the rotating sphere. Both the magnetic field and the electric charge increase while the sphere is rotating.

The increasing magnetic field and the electric charge rotating with the sphere Heats up the rubidium gas G in the hollow circular tube T, and the hot gas G interacting with the phosphor layer P produces light which bounces around in a circle inside the circular tube (because of light reflection at the junction of more dense glass g and less dense glass 1). See FIG. 4.

As the light passes through the hot rubidium gas G, its velocity is slowed down to 90 meters per second, which is slower than the velocity of rotation of the sphere if the sphere has a radius of more than 15 meters and rotates twice every secod.

According to Einstein's theory of relativity, when motion speed of object exceeds the speed of slowed light, time decreases from normal time t to Einstein time t′ See FIG. 5.

The change of time from t′ to t over distance creates force F1 and F2 in FIGS. 5, 6, 7, and the resulting increase in radial centrifugal force increases the rotational speed of the sphere M.

This provides the mechanical energy of the sphere needed to electric charge +− and magnetic field B which heats up the gas G in the tube T to produce light.

The entire system functions without energy input after a small amount of battery energy is used by electric motor E and cog wheels H and J to start rotation of sphere M through rotation of support V

Because only the top half of the circular hollow tube T has the less dense glass coating 1, the slowed light is reflected downwards through the transparent part K′ of the hub A and downwards through the transparent part of the sphere K and exits the sphere M whereupon the hinged mirrors R can reflect the light at an angle to give horizontal thrust or vertical thrust when mirrors R let the light exit vertically.

The force of light is equal to the wattage of light divided by the velocity of slowed light. Also, the change of light speed over distance, resulting in a change of time over distance provides a propulsion force for the flying saucer as the light exits K the exhaust below with velocity v, See FIG. 1, FIG. 2, FIG. 8, FIG. 9,

Because the propulsion force of the flying saucer results from a change of time over distance, the flying saucer can exceed the speed of light.

Once the sphere M is rotating with its own energy, the rotating support vertical column V is rotating with large cog wheel J which rotates small cog wheel H which rotates shaft of electric motor E and the electric motor E works as a generator to charge the battery. (The electric motor E works with direct current D.C. volts).

The four landing gear are stored in the four lower support columns C. For deployment of landing gear, tube 6 and tube 7 exit support C in a telescopic fashion.

Electric motor 10 is attached to a support which slides along a groove lengthwise In support column C which stops it from rotating while motor 10 rotates a screw 12 which advances lengthwise out of support C.

Electric motor 11 is attached to a support which slides along a groove lengthwise in tube 6 which stops it from rotating while motor 11 rotates a screw 13 which advances lengthwise out of tube 6

The portion of tube 6 (which is threaded like a bolt on the outside) which is inside of support C is labeled as 12

The portion of tube 7 (which is threaded on the outside like a bolt) which is inside of tube 6 is labeled as 13 See FIG>1, FIG. 1A, FIG. 1B,

On the end of tube 7 is a castor wheel 8 which is attached to a support 9 with the castor wheel having the ability to roll along in any direction through 360 degrees

When the electric motors 10 and 11 rotate in the opposite direction, the tubes 12 and 13 retract telescopically while rotating with a screw action. See FIG. 1, FIG. 1A, FIG. 1B

1. I claim that a magnetic coil surrounded by a circular hollow tube with four other coils on the outside of the tube equidistantly, all attached to a horizontal hub with axes vertical, with a bearing in the hub at the center of the central magnetic coil supporting a vertical support which is attached to the top and bottom of a metal sphere to fascillitate the rotation of the sphere around the hub; with a battery powered electric motor fixed to the hub with a vertical rotating shaft with a small cog wheel on the end of the shaft and driving a large cog wheel attached to the vertical support enables the electric motor to start the sphere rotating. When the sphere starts rotating around the magnetic coils, an electric charge builds up on the sphere, and increases the magnetic field further, so both magnetic field in the coils and electric charge on the sphere build up continuously. The increasing magnetic field and rotating electric charge on the sphere heats up rubidium gas in the circular hollow tube, which excites a phosphor layer on the inner wall of the tube to produce light which is slowed down while passing through the hot rubidium gas. Because the wall of the tube is made of dense glass, with the top half of the tube having a coating of less dense glass over the dense glass, slowed light bounces around in a circle inside the hollow tube, with some slowed light reflected downwards vertically through the transparent part of the hub (which the tube rests on) and through the transparent part at the exhaust at the bottom of the sphere. The force of light is equal to the wattage of slowed light divided by the velocity of the slowed light. (Slowed light has more force than ordinary light). The slowed light also causes an Einstein time change over distance which accelerates the flying saucer, along with the force of light, to propel the flying saucer vertically. Mirrors on hinges surrounding the transparent exhaust can deflect the light at an angle while the light exits the exhaust to provide horizontal propulsion. The slowed light in the circular tube causes an Einstein time change over distance radially, which increases the centrifugal force of the rotating sphere and makes the sphere rotate faster, which provides more energy than needed to produce the slowed light via the previous mentioned process. The excess mechanical energy of the rotating sphere drives the electric motor so it can work as a generator to charge the battery. At the top of the metal sphere, there are four supports at a seventy degree angle to the vertical support sloping upwards, with one end attached to the sphere, and the other end attached to the vertical support. At the bottom of the sphere, there are four supports (spaced equidistantly) sloping downwards at a seventy degree angle to the vertical support with one end attached to the vertical support, and the other end attached to the sphere. The supports at the bottom are hollow with the landing gear extending out or retracting into the supports telescopically. An electric motor is attached to a support which slides along a groove lengthwise in the hollow support which stops it from rotating while the motor rotates a hollow screw which advances lengthwise out of the hollow support. Another electric motor is attached to a support which slides along a groove lengthwise in the hollow screw which stops it from rotating while the motor rotates a screw which advances lengthwise out of the hollow screw. Both screws are threaded on the outside like a bolt. On the end of the screw in the telescopic assembly is a castor wheel which is attached to a support with the castor wheel having the ability to roll along in any direction throughout 360 degrees. When both electric motors in the landing gear rotate in the reverse direction, both screws retract telescopically while rotating with a screw action.
